(19) United States
(12) Patent Application Publication
(10) Pub. No.: US 2009/0172430 A1
(43) Pub. Date: Jul. 2, 2009

(54) ELECTRONIC DEVICE AND POWER-SAVING SETTING METHOD

(75) Inventor: Hiroki Takenouchi, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/340,163

(22) Filed: Dec. 19, 2008

(30) Foreign Application Priority Data
Dec. 27, 2007 (JP) 2007-338244

(51) Int. Cl. G06F 1/32

(52) U.S. Cl. 713/310

(57) ABSTRACT

According to one embodiment, an electronic device includes a connection unit which is connected to a network, a reception unit which receives setting information for making a power-saving setting for a device connected to the network, a sending unit which sends the setting information received by the reception unit to the network via the connection unit, and a setting unit which, upon receiving via the network the setting information from The electronic device connected to the network, makes a power-saving setting based on the received setting information.

### CROSS-REFERENCE TO RELATED APPLICATIONS

This application is based upon and claims the benefit of priority from Japanese Patent Application No. 2007-338244, filed Dec. 27, 2007, the entire contents of which are incorporated herein by reference.

### BACKGROUND

1. Field

One embodiment of the present invention relates to a power-saving setting technique for a device connected to a network and, more particularly, to an electronic device to which a power-saving setting received via a network is applicable, and a power-saving setting method.

2. Description of the Related Art

Many electronic devices, such as TV sets, have an automatic power-off function of automatically turning off power after the elapse of a predetermined time. For example, Jpn. Pat. Appln. KOKAI Publication No. 11-146103 discloses a technique of setting automatic power-off for a standalone device, thereby automatically powering off The electronic device after a predetermined time.

However, to automatically power off another device connected to a device such as a TV set, the technique described in Jpn. Pat. Appln. KOKAI Publication No. 11-146103 requires to separately set automatic power-off for the other device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary conceptual view showing an example of the arrangement of electronic devices according to an embodiment of the present invention;

FIG. 2 is an exemplary block diagram showing the arrangement of an electronic device according to the embodiment;

FIG. 3 is an exemplary flowchart illustrating a power-saving setting method using the electronic device according to the embodiment; and

FIG. 4 is an exemplary flowchart illustrating a power-saving setting method using the electronic device according to the embodiment.

### DETAILED DESCRIPTION

Various embodiments according to the invention will be described hereinafter with reference to the accompanying drawings. In general, according to one embodiment of the invention, an electronic device includes: a connection unit which is connected to a network; a reception unit which receives setting information for making a power-saving setting for a device connected to the network; a sending unit which sends the setting information received by the reception unit to the network via the connection unit; and a setting unit which, upon receiving via the network the setting information from The electronic device connected to the network, makes a power-saving setting based on the received setting information.

An embodiment of the present invention will now be described with reference to the accompanying drawing.

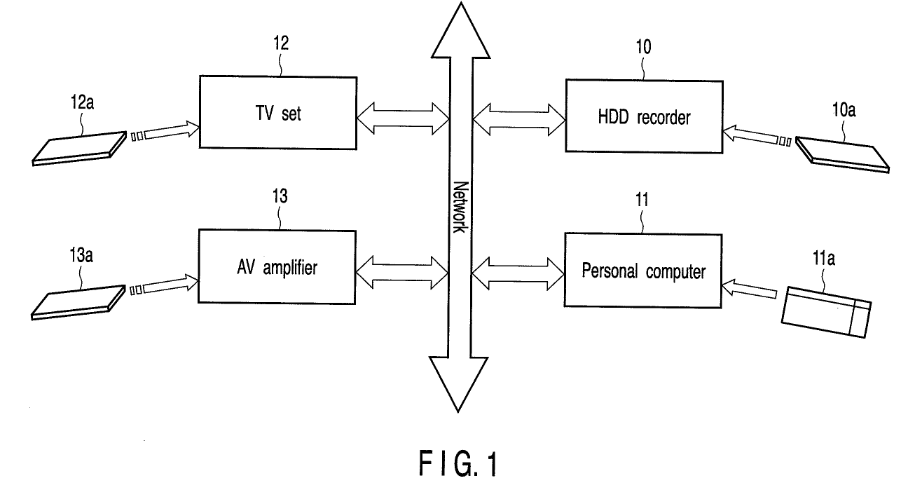

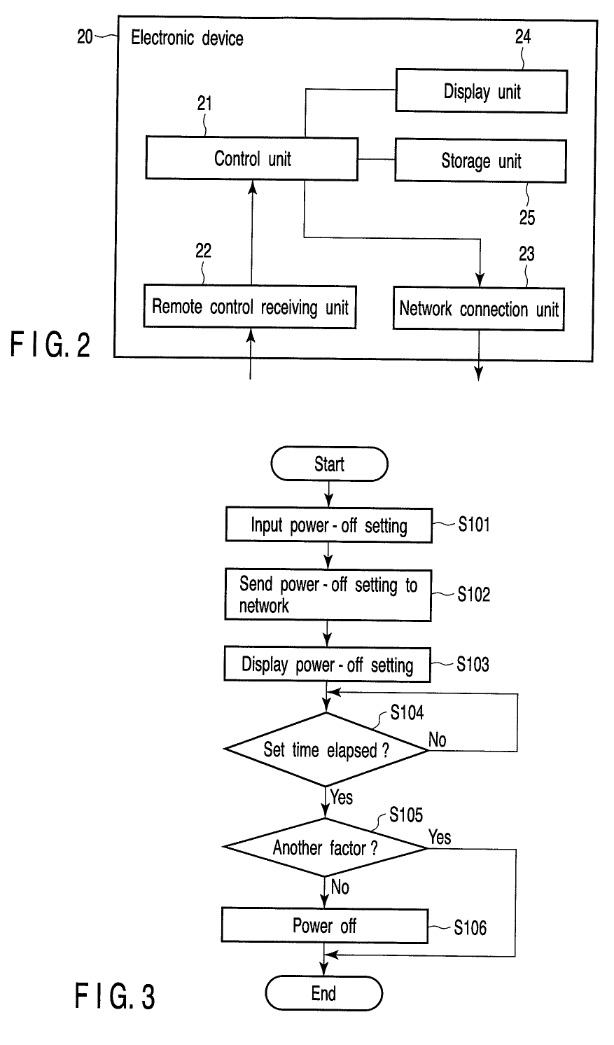

The arrangement of a network to which electronic devices according to an embodiment of the present invention are connected will be described first with reference to FIGS. 1 and 2. The electronic devices are implemented as, e.g., a television (TV set) 12, AV amplifier 13, HDD recorder 10, and personal computer (PC)

FIG. 1 is a conceptual view showing a state in which the television (TV set) 12, AV amplifier 13, HDD recorder 10, and personal computer (PC) 11 are connected to a network (e.g., a home LAN). The television (TV set) 12, AV amplifier 13, HDD recorder 10, and personal computer (PC) 11 connected to the network are operable by remote control units 12a, 13a, 10a, and 11a for operating The electronic devices, respectively. Each of the remote control units 12a, 13a, 10a, and 11a can transmit and set a power-saving setting signal for a corresponding device. Examples of the power-saving setting signal are an automatic power-off setting signal and a setting signal to lower the display brightness. A device for which the power-saving setting signal is set sends the set power-saving setting signal via the network. Any device connected to the network and capable of receiving the sent power-saving setting signal receives the signal and makes a power-saving setting based on it.

The system arrangement of an electronic device (e.g., the television 12) 20 will be explained next with reference to FIG. 2.

As shown in FIG. 2, the electronic device 20 comprises a control unit 21, remote control receiving unit 22, network connection unit 23, display unit 24, and storage unit 25.

The control unit 21 is a central control device which collectively controls the electronic device and its transmission/reception of various commands. The remote control receiving unit 22 receives a power-saving setting signal or the like from the remote control units 12a, 13a, 10a, and 11a. The network connection unit 23 is an interface to connect to the above-described network (FIG. 1). The display unit 24 includes a display panel and LED indicators provided in each device. The storage unit 25 is a storage device such as a flash memory for storing the received power-saving setting signal or the like.

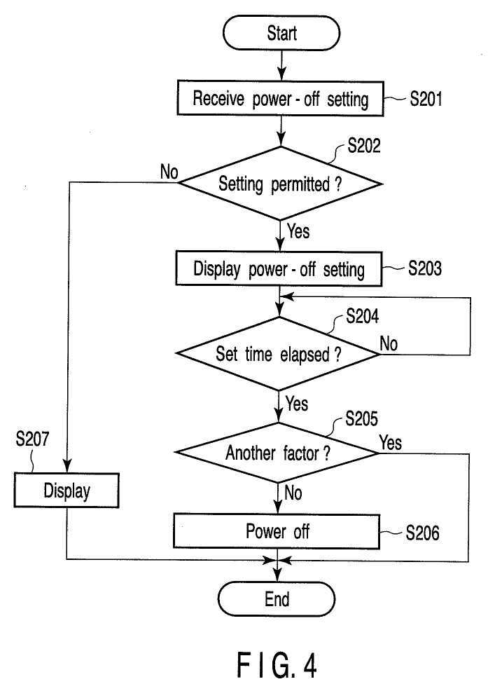

A power-saving setting method using the electronic device according to the embodiment of the present invention will be described with reference to the flowcharts in FIGS. 3 and 4 based on the above-described arrangement. In this embodiment, a description will be made assuming that the electronic device 20 that sends a power-saving setting signal is, e.g., the television 12.

Upon receiving a power-saving setting signal from the remote control units 12a, 13a, 10a, and 11a (block S101), the control unit 21 of the electronic device 20 (television 12) sends the received power-saving setting signal to the network (block S102). The signal is sent to the network as a broadcast command of, e.g., HDMI-CEC (High-Definition Multimedia Interface-Consumer Electronics Control). The broadcast command is receivable by all devices connected to the network. Any device capable of receiving the sent broadcast command receives the same but returns no response to acknowledge the receipt. Since a device that could not receive the command because of, e.g., power-off does not particularly return a command to notify the nonreceipt, resending of the power-saving setting signal is not performed. Use of the broadcast command makes it possible to simply and easily send the power-saving setting signal to The electronic devices connected to the network without building a strictly set network.

The television 12 which has sent the power-saving setting signal to the network displays, on the display unit 24, the setting of the power-saving setting signal (block S103). If automatic power-off is set by the power-saving setting signal, for example, “automatic power-off 60 min” is displayed.

When the automatic power-off set time of, e.g., 60 min has elapsed (YES in block S104), the television determines whether any other factor that impedes automatic power-off exists (block S105). If it is determined that any other factor that impedes automatic power-off exists, and for example, if the user has operated the television 12, the power-saving setting of automatic power-off is not applied.

If it is determined that no factor impedes automatic power-off, automatic power-off is done to automatically power off the television 12 (block S106).

The operation of a device (AV amplifier 13, HDD recorder 10, or personal computer 11) connected to the network, other than The electronic device (television 12) that has sent the power-saving setting signal, will be described next with reference to the flowchart in FIG. 4.

A device (AV amplifier 13, HDD recorder 10, or personal computer 11) connected to the network, other than The electronic device (television 12) that has sent the power-saving setting signal, receives the power-saving setting signal such as an automatic power-off setting signal via the network (block S201). The electronic device, e.g., the HDD recorder 10 that has received the signal determines whether automatic power-off setting is permitted (block S202). If the HDD recorder 10 determines that automatic power-off setting is not permitted (NO in block S202), and for example, if a setting to inhibit automatic power-off setting has been made in advance, a message (e.g., “automatic power-off is inhibited”) is displayed so no power-saving setting is made.

If the HDD recorder 10 determines that automatic power-off setting is permitted (YES in block S202), and a predetermined time, i.e., the automatic power-off set time of, e.g., 60 min has elapsed (YES in block S204), the HDD recorder determines whether any other factor that impedes automatic power-off exists (block S205). If it is determined that any other factor that impedes automatic power-off exists, and for example, if a recording reservation is present (YES in block S205), the power-saving setting is not done.

If it is determined that no factor impedes automatic power-off (NO in block S205), the automatic power-off is done to automatically power off the HDD recorder 10 (block S206). In the above-described embodiment, a broadcast command of, e.g., HDMI-CEC is used. However, the present invention is not limited to this, and any other broadcast command is usable.

It is, accordingly, an object of the invention to provide an information processing apparatus and a power supply control method which are capable of saving electrical power at both a control unit and a converter.

According to the above-described embodiments, power-saving setting information is sent to each device using a broadcast command. This allows to easily and synchronously apply the power-saving setting to The electronic devices connected to the network.

Note that the present invention is not exactly limited to the above-described embodiments, and constituent elements can be modified in the execution stage without departing from the spirit and scope of the invention.

Various inventions can be formed by properly combining a plurality of constituent elements disclosed in the above-described embodiments. For example, several constituent elements may be omitted from all the constituent elements described in the embodiment. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a network connection module configured to be connected to a network;
a reception module configured to receive setting information for setting a power-saving setting for a device connected to the network;
a transmitter configured to send the setting information received by the reception module to the network via the network connection module; and
a setting module configured to set a power-saving setting based on the received setting information upon receiving the setting information from the electronic device via the network.

2. The electronic device of claim 1, which further comprises a display configured to display the setting information, and the display is configured to display a current setting information when the setting module sets an automatic power-off setting based on the setting information.

3. The electronic device of claim 1, which further comprises a display configured to display the setting information,
wherein the setting module is configured to set a setting to decrease brightness of the display.

4. The electronic device of claim 1, wherein the setting module is configured to set a first setting if a priority of the first setting is higher than a priority of the power-saving setting.

5. The electronic device of claim 1, wherein the setting module is configured to set a power-saving setting that has been last received upon receiving a plurality of power-saving settings.

6. A power-saving setting method used in an electronic device comprising a network connection module configured to be connected to a network, comprising:
generating setting information for setting a power-saving setting for a device connected to the network;
sending the generated setting information to the network via the network connection module
receiving via the network the setting information from the electronic device connected to the network; and
setting a power-saving setting based on the received setting information.

7. The method of claim 6, which further comprises a display configured to display the setting information, and
the display further configured to display a current setting information when the power-saving setting is an automatic power-off setting based on the setting information.

8. The method of claim 6, which further comprises a display configured to display the setting information, further comprising:
decreasing brightness of the display in the power-saving setting.

9. The method of claim 6, wherein a first setting is set if a priority of the first setting is higher than a priority of the power-saving setting.

10. The method of claim 6, wherein a power-saving setting that has been last received is set upon receiving a plurality of power-saving settings.
